(19) United States
(12) Patent Application Publication
(10) Pub. No.: US 2026/0051614 A1
(43) Pub. Date: Feb. 19, 2026

(54) BATTERY SEPARATORS AND METHODS OF MAKING THE SAME

(71) Applicant: Magnera Corporation, Charlotte, NC (US)

(72) Inventor: David Rittenhouse, Lillian, AL (US)

(21) Appl. No.: 19/297,776

(22) Filed: Aug. 12, 2025

Related U.S. Application Data
(60) Provisional application No. 63/682,703, filed on Aug. 13, 2024.

(51) Int. Cl. H01M 50/44; D01F 1/02; D01F 6/06; D04H 1/4291; D04H 1/44; D04H 3/16; H01M 10/0525; H01M 50/417; H01M 50/489

(52) U.S. Cl. CPC H01M 50/44; D01F 1/02; D01F 6/06; D04H 1/4291; D04H 1/44; D04H 3/16; H01M 10/0525; H01M 50/417; H01M 50/489; D10B 2321/022; D10B 2401/00; D10B 2505/00

(57) ABSTRACT

Described herein are articles comprising nonwoven fabrics and methods of making said nonwoven fabrics. Methods of making nonwoven fabrics may include forming polymer fibers from a bulk polymer in the presence of a nucleating agent, and forming a nonwoven fabric from the polymer fibers

### CROSS-REFERENCE TO RELATED APPLICATION

This application claims the benefit of U.S. Provisional Application No. 63/682,703 filed Aug. 13, 2024, the entire contents of which are incorporated by reference herein.

### FIELD OF THE INVENTION

This disclosure relates in general to improved nonwoven fabric compositions. In particular, this disclosure relates to nonwoven fabric compositions for use as battery separators in, for example, lithium-ion batteries and methods of manufacturing said battery separators.

### BACKGROUND OF THE DISCLOSURE

Batteries have been utilized for many years as electrical power generators in remote locations. Through the controlled movement of electrolytes (ions) between electrodes (anode and cathode), a power circuit is generated, thereby providing a source of electricity that can be utilized until the electrolyte source is depleted and no further electrical generation is possible. In more recent years, rechargeable batteries have been created to allow for longer lifetimes for such remote power sources. All in all, however, the capability of reusing such a battery has led to greater potentials for use, particularly through, for example, handheld devices such as cell phones and laptop computers and, even more so, to the possibility of automobiles that require electricity to function.

Such batteries typically include at least five distinct components. A case (or container) that houses everything in a secure and reliable manner to prevent leakage to the outside as well as environmental exposure inside. Within the case are an anode and a cathode, separated effectively by a battery separator, as well as an electrolyte solution (e.g., low viscosity liquid) that transports through the battery separator between the anode and cathode. Rechargeable batteries can run the gamut of small and portable devices, with a great deal of electrical generation potential in order to remain effective for long periods between charging episodes, to vary large types present within automobiles, as an example, that include large electrodes (at least in surface area) that must not contact one another and large amounts of electrolytes that must consistently and constantly pass through a membrane to complete the necessary circuit, all at a level of power generation conductive to providing sufficient electricity to run an automobile engine. And with the further emergence of electrical automobiles, the expended demand for such batteries is only expected to grow. As such, the capability and versatility of battery separators in the future must meet certain requirements that have yet to be provided within the current industry.

Battery separators have been used since the advent of closed-cell batteries to provide necessary protection from unwarranted contact between electrodes as well as to permit effective transport of electrolytes within power generating cells. Typically, such materials have been of film structure, sufficiently thin to reduce the weight and volume of a battery device while imparting the necessary properties noted above at the same time. Such separators must exhibit other characteristics as well to allow for proper battery function. These include chemical stability, suitable porosity of ionic species, effective pore size for electrolyte transfer, proper permeability, effective mechanical strength (both during construction of the battery as well as in-service life), and the capability of retaining dimensional and functional stability when exposed to high temperatures (as well as the potential for shutdown if the temperature rises to an abnormally high level.).

Battery separator materials must be of sufficient strength and constitution to withstand several different scenarios. Initially, the separator must not suffer tears or punctures during the stresses of battery assembly. In this manner, the overall mechanical strength of the separator is extremely important, particularly as high tensile strength material in both the machine and cross directions allows the manufacturer to handle such a battery separator more easily and without stringent guidelines, so the battery separator does not suffer structural failure or loss during such a procedure. Additionally, from a chemical perspective, the battery separator must withstand the oxidative and reductive environment within the battery itself, particularly when fully charged. Any failure during use, specifically in terms of structural integrity permitting abnormally high amounts of electrolyte to pass or for the electrodes to touch, would destroy the power generation capability and render the battery totally ineffective. Thus, even above the ability to weather chemical exposure, such a separator must also not lose dimensional stability (i.e., warp or melt) or mechanical strength during storage, manufacture, and use, either, for the same reasons noted above.

At the same time, a battery separator must be of proper thickness to facilitate the high energy and power densities of the battery itself. A uniform thickness is quite important too to allow for a long-life cycle as any uneven wear on the battery separator will be the weak link in terms of proper electrolyte passage, as well as electrode contact prevention. The ability, however, to provide an extremely thin, uniform dimension, within such battery separators has proved to be rather difficult, particularly since a thickness reduction of an already thin structure tends to compromise separator strength.

Moreover, regarding pore size, battery separators must exhibit proper porosity and pore sizes to accord the proper transport of ions through such a membrane (as well as proper capacity to retain a certain amount of liquid electrolyte to facilitate such ion transfer during use). The pores themselves should be sufficiently small to prevent electrode components from entering and/or passing through the membrane, while also allowing for proper rate of transfer of electrolyte ions therethrough. Also, uniformity in pore sizes, as well as pore size distribution, provides a more uniform result in power generation over time as well as more reliable long-term stability for the overall battery as uniform wear on the battery separator allows for longer life cycles. It additionally can be advantageous to ensure the pores therein may properly close upon exposure to abnormally high temperatures to prevent excessive and undesirable ion transfer upon battery failure (e.g., preventing fires and other similar hazards). Thus, providing uniformly small pore sizes (and thus proper porosity measurements for such a purpose) within a thin, dense nonwoven structure has yet to be fully optimized. Film structures may be manufactured to certain dimensions, but porosity reductions are designed in such separators, rather than produced or at least modified through further treatments past initial manufacture. There remains a drive for low pore sizes to provide, for example, beneficial protections in terms of electrode contact, while maintaining sufficient durability and resilience to mechanical stresses.

Furthermore, the battery separator must not impair the ability of the electrolyte to completely fill the entire cell during manufacture, storage, and use. Thus, the battery separator must exhibit proper wicking and/or wettability during such phrases to ensure the electrolyte in fact may properly generate and transfer ions through the membrane; if the separator were not conductive to such a situation, then the electrolyte would not properly reside on and in the separator pores and the necessary ion transmission would not readily occur. In other words, generally the smaller the battery separator the better. Hence, providing a strong, thin, and dense structure would be highly desirable.

Battery separators have been provided to the industry having nano fiber constituents. Such structures allow, depending on manufacturing steps and procedures, a user to dial in a desired level of porosity with effective isotropic strength levels. Such separators are effective in terms of air resistance, as well, providing highly desirable structures within the lithium ion and other like battery markets. A drawback does exist, however, in terms of less than desired durability and resilience.

One procedure to manufacture nano fiber-based battery separators has been to utilize a melt-blowing process. In a type of melt-blowing, a nonwoven web is formed by extruding molten polymer through a die and then attenuating and breaking the resulting filaments with a hot, high-velocity gas stream. This process generates short, very fine fibers that can be collected on a moving belt where they bond with each other during cooling. Melt-blown webs can be made that exhibit very good barrier properties and can be utilized as battery separators. An efficient use of melt blown technology is discussed in U.S. Pat. No. 6,833,104, the entire disclosure of which is incorporated herein by reference. Improved methods and apparatus for producing polymeric nanofibers and improvements in melt blown technology that permit the production of polymeric nanofibers of small cross section are discussed in U.S. Pat. No. 10,041,188, the entire disclosure of which is incorporated herein by reference.

Melt-blown fibers are most typically spun from polypropylene. Other polymers that have been spun as melt-blown fibers include polyethylene, polyamides, polyesters, and polyurethanes. Melt-blown fibers have been incorporated into a variety of nonwoven fabrics, including, for example, battery separators.

While existing nonwoven webs formed including melt-blown fibers have been used as battery separators, there is a desire for battery separators having improved physical resilience of the separator material to abrasion and puncture during the construction of a battery and in-service life. In addition, properties of such battery separator webs should be improved to increase rate and efficiency with which a battery separator wets out in the battery electrolyte, which would improve battery manufacture. Furthermore, such materials can be improved to achieve faster charging cycles, reduced energy consumption, and an extended battery life. Finally, the physical properties of such nonwovens should be improved to prevent or reduce the formation of dendrites and enhance resilience to puncture by dendrites.

### SUMMARY OF THE DISCLOSURE

Various aspects of the present disclosure are directed to improved nonwoven fabric compositions for use in various applications such as battery separators in, for example, lithium-ion batteries. Various aspects of the present disclosure are directed to are also directed to methods of manufacturing nonwoven fabric compositions for use as battery separators. Various non-limiting aspects of such nonwoven fabric compositions according to the disclosure are presented below.

In some instances, a first aspect of the disclosure can be described as an article comprising a nonwoven fabric, where the nonwoven fabric is prepared by a process comprising forming polymer fibers from a bulk polymer in the presence of a nucleating agent; and forming a nonwoven fabric from the polymer fibers.

In some instances, a second aspect of the disclosure can be described as an article according to the first aspect, wherein the article is in the form of a sheet having a thickness of up to about 50 μm.

In some instances, a third aspect of the disclosure can be described as an article according to the first or second aspect, wherein the article is a battery separator.

In some instances, a fourth aspect of the disclosure can be described as an article according to any one of the first through third aspects, wherein the article is a lithium-ion battery separator.

In some instances, a fifth aspect of the disclosure can be described as an article according to any one of the first through fourth aspects, wherein the bulk polymer comprises one or more of polypropylene, polyethylene, polyethylene terephthalate, a nylon, polycaprolactam, polyphenylene sulfide, polyetherimide, polyacrylate, polyacrylamide and polyacrylonitrile.

In some instances, a sixth aspect of the disclosure can be described as an article according to any one of the first through fifth aspects, wherein the bulk polymer comprises polypropylene.

In some instances, a seventh aspect of the disclosure can be described as an article according to any one of the first through fifth aspects, wherein the bulk polymer consists of polypropylene.

In some instances, an eighth aspect of the disclosure can be described as an article according to any one of the first through seventh aspects, wherein the nucleating agent is selected from the group consisting of talc, nanoclays, metal oxides, alkaline earth metal phosphates, alkaline earth metal carbonates and alkaline earth metal sulphates.

In some instances, a ninth aspect of the disclosure can be described as an article according to any one of the first through seventh aspects, wherein the nucleating agent is selected from the group consisting of sodium benzoate, lithium benzoate, sodium succinate, organophosphates, and salts thereof, phosphate esters, bicycloheptane salts, sorbitol-based compounds, trisamides, γ-quinacridone, dimethyl 5-sulfoisophthalate sodium salt, and alkyl dicarboxylic acids and salts thereof.

In some instances, a tenth aspect of the disclosure can be described as an article according to any one of the first through ninth aspects, wherein forming the polymer fibers from the bulk polymer in the presence of the nucleating agent comprises subjecting a mixture of the bulk polymer and the nucleating agent to a melt blowing process.

In some instances, an eleventh aspect of the disclosure can be described as an article according to any one of the first through tenth aspects, wherein the polymer fibers are formed from a mixture having about 0.1 to about 10 parts by weight of the nucleating agent and about 90 to about 99.9 parts by weight of the bulk polymer.

In some instances, a twelfth aspect of the disclosure can be described as an article according to any one of the first through tenth aspects, wherein the polymer fibers are formed from a mixture having about 1.5 to about 6 parts by weight of the nucleating agent and about 94 to about 98.5 parts by weight of the bulk polymer.

In some instances, a thirteenth aspect of the disclosure can be described as an article according to any one of the first through twelfth aspects, wherein forming the nonwoven fabric from the polymer fibers comprises collecting the polymer fibers on a substrate; and consolidating the polymer fibers on the substrate to form the nonwoven fabric.

In some instances, a fourteenth aspect of the disclosure can be described as an article according to the thirteenth aspect, wherein the substrate is a forming wire, a fabric or a drum.

In some instances, a fifteenth aspect of the disclosure can be described as an article according to the thirteenth or fourteenth aspect, wherein consolidating the polymer fibers on the substrate is performed by any one of a calendering process, compaction rolling process and a creping process.

In some instances, a sixteenth aspect of the disclosure can be described as an article according to any one of the first through sixth and eighth through fifteenth aspects, wherein the bulk polymer comprises a mixture of at least two of polypropylene, polyethylene, polyethylene terephthalate, a nylon, polycaprolactam, polyphenylene sulfide, polyetherimide, polyacrylate, polyacrylamide and polyacrylonitrile.

In some instances, a seventeenth aspect of the disclosure can be described as an article according to any one of the first through sixteenth aspects, wherein the nonwoven fabric exhibits an air permeability of more than 10 cm³/s.

In some instances, an eighteenth aspect of the disclosure can be described as an article according to any one of the first through seventeenth aspects, wherein the nonwoven fabric exhibits a shrinkage of less than 1% in one or both of a machine direction and a transverse direction.

In some instances, a nineteenth aspect of the disclosure can be described as battery comprising an article according to any one of the first through eighteenth aspects.

In some instances, a twentieth aspect of the disclosure can be described as battery according to the nineteenth aspect, further comprising an anode, a cathode, and an electrolyte solution comprising a lithium salt.

### DETAILED DESCRIPTION OF THE DISCLOSURE

All the features of this disclosure and its preferred embodiments will be described in full detail in connection with the following illustrative embodiments. In no manner has the description of the inventive battery separators, battery cells, and methods of manufacture therewith been made in any attempt to limit the scope thereof.

It should be noted that features described in connection with one exemplary embodiment or exemplary aspect may be combined with any other exemplary embodiment or exemplary aspect, in particular features described with any exemplary embodiment of a nonwoven fabric composition may be combined with any other exemplary embodiment of a nonwoven fabric composition and/or battery separator, with any exemplary embodiment of a method for producing a nonwoven fabric composition and/or battery separator, with any exemplary embodiment of a battery separator and with any exemplary embodiment of a use and vice versa, unless specifically stated otherwise.

Where an indefinite or definite article is used when referring to a singular term, such as “a”, “an”, or “the”, a plural of that term is also included and vice versa, unless specifically stated otherwise, whereas the word “one” or the number “1”, as used herein, typically means “just one” or “exactly one.”

The expression “comprising”, as used herein, includes not only the meaning of “comprising”, “including” or “containing”, but may also encompass “consisting essentially of” and “consisting of”.

Unless specifically stated otherwise, the expression “at least a part of”, as used herein, may mean at least 5% thereof, in particular at least 10% thereof, in particular at least 15% thereof, in particular at least 20% thereof, in particular at least 35% thereof, in particular at least 40% thereof, in particular at least 45% thereof, in particular at least 50% thereof, in particular at least 55% thereof, in particular at least 60% thereof, in particular at least 65% thereof, in particular at least 70% thereof, in particular at least 75% thereof, in particular at least 80% thereof, in particular at least 85% thereof, in particular at least 90% thereof, in particular at least 95% thereof, in particular at least 98% thereof, and may also mean 100% thereof.

The term “nonwoven fabric”, as used herein, may in particular mean a web of individual fibers which are at least partially intertwined, but not in a regular manner or repeating pattern as in a knitted or woven fabric.

Various aspects of the present disclosure are directed to nonwoven fabric compositions comprising a nonwoven fabric and a nucleating agent. Compositions according to various aspects of the present disclosure may be useful in numerous applications. In some instances, nonwoven fabric compositions according to various aspects of the disclosure are especially useful as a battery separator. In some instances, nonwoven fabric compositions according to various aspects of the disclosure are especially useful as a battery separator in a lithium ion battery. Nonwoven fabric compositions according to the present disclosure, produced with the use of nucleating agents, exhibit higher crystallinities than nonwoven fabric compositions produced using the same procedures but without the use of nucleating agents. Nonwoven fabric compositions according to the present disclosure, produced with the use of nucleating agents, also exhibit tensile strengths similar to or higher than nonwoven fabric compositions produced using the same procedures but without the use of nucleating agents. Nonwoven fabric compositions according to the present disclosure, produced with the use of nucleating agents, also exhibit a lowered propensity to shrink (percent shrinkage) compared to nonwoven fabric compositions produced using the same procedures but without the use of nucleating agents. For example, nonwoven fabric compositions produced according to various aspects of the disclosure exhibit less than 1% shrinkage, in some instances less than 0.9% shrinkage, in some instances less than 0.8% shrinkage, in some instances less than 0.7% shrinkage, in some instances less than 0.6% shrinkage, in some instances less than 0.5% shrinkage, in some instances less than 0.4% shrinkage, and in some instances 0.3% or less shrinkage in one or both of a machine direction and a transverse direction. Nonwoven fabric compositions according to the present disclosure, produced with the use of nucleating agents, also exhibit air permeabilities that are markedly higher than nonwoven fabric compositions produced using the same procedures but without the use of nucleating agents. For example, nonwoven fabric compositions produced according to various aspects of the disclosure exhibit air permeabilities of 10 cm³/s or more, in some instances 12.5 cm³/s or more, 15 cm³/s or more, 17.5 cm³/s or more, 20 cm³/s or more, 25 cm³/s or more, and 30 cm³/s or more.

Nonwoven fabrics for use in nonwoven fabric compositions may be constructed from any polymer or polymer blends that accord suitable chemical and heat resistance in conjunction with internal battery cell conditions, as well as the capability to form suitable fiber structures within the ranges indicated, and further the potential to be treated through a fibrillation or like technique to increase the surface area of the fibers themselves for entanglement facilitation during nonwoven fabrication. Such fibers may be made from longstanding fiber manufacturing methods such as melt spinning, wet spinning, solution spinning, melt blowing, spunbonding, electrospinning, carding, and others. Fibers produced according to various aspects of the disclosure may be cut to an appropriate length for further processing. Such fibers may also be fibrillated into smaller fibers or fibers that advantageously form wet laid nonwoven fabrics.

Nonwoven fabrics for use in nonwoven fabric compositions according to various aspects of the present disclosure generally include a blend of at least two polymeric fibers. In some instances, the polymeric fibers are thermoplastic fibers produced by, for example, a melt spinning or a melt blowing procedure. Suitable polymeric fibers include, but are not limited to, polypropylene (PP) fibers, polyethylene (PE) fibers, polyethylene terephthalate (PET) fibers, nylon (a polyamide) fibers, polycaprolactam fibers, polyphenylene sulfide (PPS) fibers, polyetherimide (PEI) fibers, polyacrylate (PA) fibers, polyacrylamide (PAA) fibers, polyacrylonitrile (PAN) fibers and combinations thereof. Suitable nylons include, but are not limited to, Nylon 6 (a [—NH—(CH₂)₅—CO—]ₙ polymer made from ε-caprolactam), Nylon 6,10 (a [—NH—(CH₂)₆—NH—CO—(CH₂)₈—CO—]ₙ polymer made from hexamethylenediamine and sebacic acid), Nylon 6,6 (a [—NH—(CH₂)₆—NH—CO—(CH₂)₄—CO—]ₙ polymer made from hexamethylenediamine and adipic acid), Nylon 6/66 (a copolymer of Nylon 6 and Nylon 6,6) and Nylon 66/610 (a copolymer of Nylon 6,6 and Nylon 6,10). The polymeric fibers can have an average fiber length ranging from about 0.3 microns to about 5 microns, alternatively from about 0.4 microns to 4 microns, alternatively from about 0.5 microns to 3 microns, alternatively from about 0.75 microns to 2.5 microns, and alternatively from about 1 micron to 2 microns.

In some instances, nonwoven fabrics according to the disclosure can contain nanofibers, which may be made through several longstanding techniques to make nanofibers. One example includes islands-in-the-sea, such as the Nano-Front fiber available from Teijin which are polyethylene terephthalate fibers with a diameter of 700 nm. Hills also makes and sells equipment that enables islands-in-the-sea nanofibers. Another example would be centrifugal spinning. Dienes and FiberRio are both marketing equipment when would provide nanofibers using the centrifugal spinning technique. Another example is electrospinning, such as practiced by DuPont, E-Spin Technologies, or on equipment marketed for this purpose by Elmarco. Still another technique to make nanofibers is to fibrillate them from film or from the fibers. Nanofibers fibrillated from films are disclosed in U.S. Pat. Nos. 6,110,588, 6,432,347, and 6,432,532, which are incorporated herein in their entirety by reference. Nanofibers fibrillated from other fibers may be done so under high shear, abrasive treatment. Nanofibers made from fibrillated cellulose and acrylic fibers are marketed by Engineered Fiber Technologies under the brand name EFTEC™. Any such nanofibers may also be further processed through cutting and high shear slurry processing to separate the fibers and enable them for wet laid nonwoven processing. Such high shear processing may or may not occur in the presence of the required microfibers. Nanofibers that are made from fibrillation in general have a transverse aspect ratio that is different from one, such transverse aspect ratio described in full in U.S. Pat. No. 6,110,588. In some instances, the nanofibers preferably exhibit a transverse aspect ratio of greater than 1.5:1, in some instances more preferably greater than 3.0:1, and in other instances more preferably greater than 5.0:1. In some instances, acrylic and polyolefin fibers are particularly preferred for such a purpose, with fibrillated acrylic fibers, are even more particularly preferred. Again, however, this is provided solely as an indication of a potentially preferred type of polymer for this purpose and is not intended to limit the scope of possible polymeric materials or polymeric blends for such a purpose. One particular embodiment of the combination of microfiber and nanofibers is the EFTEC™ A-010-4 fibrillated polyacrylonitrile fibers, which have high populations of nanofibers as well as microfibers. By way of example, these fibers can be used as a base material, to which can be added further microfibers or further nanofibers as a way of controlling the pore size and other properties of the nonwoven fabric.

Nonwoven fabrics according to various aspects of the present disclosure may include a blend of at least two different types of polymeric fibers, where the amount of the first type of polymer fibers (also referred to herein as “the majority polymer fibers”) is greater than the amount of the second type of polymer fibers (also referred to herein as “the minority polymer fibers”). In some instances, nonwoven fabrics comprising a blend of polypropylene fibers and nylon fibers are preferred. Nonwoven fabrics comprising a blend of polypropylene fibers and nylon fibers can be made to a polypropylene to nylon weight:weight ratio ranging from about 99:1 to about 75:25. In some instances, such nonwoven fabrics can have a polypropylene to nylon weight:weight ratio ranging from about 95:5 to about 75:25, alternatively from about 90:10 to about 80:20. In some instances, nonwoven fabrics comprising a blend of polypropylene fibers (majority polymer fibers) and nylon fibers (minority polymer fibers) as discussed above and a minor amount of polyethylene terephthalate fibers such as, for example, in an amount of less than 10 wt %, less than 5 wt %, less than 2.5 wt %, or less than 1 wt % of the total weight of the fibers in the nonwoven fabric.

In accordance with various aspects of the present disclosure, polymer fibers, for use in the preparation of nonwoven fiber compositions according to various aspects of the disclosure, are fabricated with the aid of a nucleating agent. Suitable nucleating agents include, but are not limited to, talc (a hydrated magnesium silicate), sodium benzoate, lithium benzoate, sodium succinate, organophosphates and salts thereof (for example, sodium bis(2,2-methylene-bis(4,6-di-tert-butylphenyl)phosphate)), phosphate esters, bicycloheptane salts, sorbitol-based compounds (for example, 1,3:2,4-bis(3,4-dimethylbenzylidene) sorbitol and bis(4-propylbenzylidene) propyl sorbitol), trisamides, nanoclays such as montmorillonite, metal oxides such as titanium dioxide or magnesium oxide, alkaline earth metal phosphates, alkaline earth metal carbonates, alkaline earth metal sulphates, γ-quinacridone, dimethyl 5-sulfoisophthalate sodium salt, alkyl dicarboxylic acids (such as adipic acid, suberic acid, and pimelic acid) or salts thereof.

The use of nucleating agents during fabrication of polymer fibers, for nonwoven fabric compositions according the disclosure, promotes crystallization of the polymer fibers during high temperature fabrication processes (in, for example, melt spinning or melt blowing processes). The use of nucleating agents therefore produces polymer fibers that are more crystalline and less amorphous than polymer fibers fabricated without the use of nucleating agents. The use of nucleating agents also helps to minimize twinning, roping and spinning of the polymer fibers during fabrication due, at least in part, to the increased polymer crystallization rate.

As discussed above, nonwoven fabrics for use in nonwoven fabric compositions according to the disclosure may be formed by manufacturing methods such as, for example, melt spinning, wet spinning, solution spinning, melt blowing, spunbonding, electrospinning, carding, and others.

In some instances, melt spinning and melt blowing manufacturing processes are preferred. In some instances, melt blowing manufacturing processes are especially preferred. An exemplary melt blowing process for the fabrication of a nonwoven fabric compositions according to the disclosure include the following steps. As one of ordinary skill in the art may appreciate additional steps may be added to the exemplary melt blowing process without departing from the scope of the invention.

In a first step of an exemplary nonwoven fabric composition manufacturing process, a bulk polymer, from which the polymer fibers of a nonwoven fabric compositions according to the disclosure are produced, and a nucleating agent are combined and formed into a homogeneous or substantially homogeneous mixture. Generally, the bulk polymer and the nucleating agent are in the form of particles, granules, a powder, or another suitable solid form at the time of mixing. The polymer and nucleating agent are combined in amounts that would result in a mixture having about 0.1 to about 10 parts by weight of the nucleating agent and about 90 to about 99.9 parts by weight of the polymer. In some instances, the polymer and nucleating agent are combined in amounts that would result in a mixture having about 0.5 to about 8 parts by weight of the nucleating agent and about 92 to about 99.5 parts by weight of the polymer. In some instances, the polymer and nucleating agent are combined in amounts that would result in a mixture having about 1 to about 7 parts by weight of the nucleating agent and about 93 to about 99 parts by weight of the polymer. In some instances, the polymer and nucleating agent are combined in amounts that would result in a mixture having about 1.5 to about 6 parts by weight of the nucleating agent and about 94 to about 98.5 parts by weight of the polymer. In some instances, the polymer and nucleating agent are combined in amounts that would result in a mixture having about 2 to about 5 parts by weight of the nucleating agent and about 95 to about 98 parts by weight of the polymer. In some instances, the polymer and nucleating agent are combined in amounts that would result in a mixture having about 2 to about 4 parts by weight of the nucleating agent and about 96 to about 98 parts by weight of the polymer.

In a second step of an exemplary nonwoven fabric composition manufacturing process, the mixture of bulk polymer and nucleating agent is subjected to a melt blowing process to produce the polymer fibers.

In a third step of an exemplary nonwoven fabric composition manufacturing process, the polymer fibers produced in the second step are collected onto, for example, a forming wire, fabric or drum.

In a fourth step, the collected polymer fibers are formed into a nonwoven fabric sheet. Generally, this step is a consolidation step where the polymer fibers are compressed under controlled temperature and pressure to the compact the fibers into a nonwoven fabric sheet to a target sheet thickness. During compaction, adjacent polymer fibers may bond to form a porous nonwoven fabric. The porosity, the degree of inter-fiber fiber bonding, the strength and flexibility, and so on, of the nonwoven fabric sheet can be varied based upon, at least partly, the compaction parameters and the physical and chemical properties of the polymer fibers. Compaction methods for forming the polymer fibers into a nonwoven fabric sheet may include, but are not limited to calendering, compaction rolling, creping, and so on. In some instances, calendering is the preferred method of compacting the polymer fibers collected during the third step.

As one of ordinary skill in the art may appreciate, certain parameters related to the melt blowing process, such as line speed, temperature of the melt blowing die lip, the distance between the die lip and the collecting surface, the vacuum pressure applied to draw the formed fibers onto the collecting surface air flow, temperature and temperature control of the air flow and so on, may be varied based at least partly upon the chemical composition and physical properties of the bulk polymer and nucleating agent.

In accordance with various aspects of the disclosure, nonwoven fabric compositions can be used as battery separators. In general, battery separators according to the disclosure can be fabricated to have thicknesses ranging from about 5 microns to about 50 microns, alternatively from about 5 microns to about 40 microns, and alternatively from about 5 microns to about 30 microns. When used in lithium ion batteries, it may be preferable, in some instances, that the battery separators have a thickness in the range of 7 microns to 30 microns. When the battery separator is fabricated to have a sheathing or coating, as described elsewhere, the sheathing or coating can have a thickness from a few nanometers to a few microns, for example, from 5 nanometers to 10 microns. In some instances, battery separators can be made of a single layer of a nonwoven fabric composition. In some instances, battery separators can be made of multiple layers (for example, two, three or more layers) of nonwoven fabrics, where each layer is made of the same nonwoven fabric composition or different nonwoven fabric compositions. As such, a fourth step of an exemplary nonwoven fabric composition manufacturing process may include forming a plurality of shaped nonwoven fabrics from a nonwoven fabric sheet produced in the third step. For example, if a nonwoven fabric according to the present disclosure is to be used as a separator in a coin cell battery, a disc-shaped nonwoven fabric can be produced from a nonwoven fabric sheet. Various methodologies such as, for example, cutting, stamping and so on, may be used to forming a plurality of shaped nonwoven fabrics from a nonwoven fabric sheet.

### Examples

Example 1—Synthesis of Polypropylene Fiber Separator (Control). In this example, a polypropylene fiber-based separator is prepared. The separator was produced using a melt blowing process. Homopolymer polypropylene with a melt flow index (MFI) of 1200 was used to prepare the polypropylene fibers. The fibers were produced using a line speed of 13.1 meters per minute, with a melt temperature of 244° C. at the die lip. The basis weight of the produced fabric is 8 gsm, and the average fiber size of the produced polypropylene fibers was 1.83 microns. The produced fibers were then calendered using a temperature of 200-210° F. (about 93 to about 99° C.) and a pressure of 200 psi (about 1379 kilopascals (kPa)) to form a polypropylene fiber-based sheet having a final thickness of 15 microns. The polypropylene fiber-based sheet can then be wound onto a roll and stored until cut or stamped into a desired shapes, such as, for example, a circular disk for use as a separator in a coin cell battery. Characterization data that were obtained on the resulting polypropylene fiber-based sheet are displayed in Table 1.

Example 2—Synthesis of Polypropylene Fiber Separator with the aid of nucleating agent (Inventive). In this example, a polypropylene fiber-based separator is prepared using the same procedure as Example 1, with the exception that 2 wt % of a sorbitol-based nucleating agent (Ultraclear GB 110BW, Milliken & Company) was added to the homopolymer polypropylene during the melt blowing process and the melt temperature at the die lip was 248° C. The produced polypropylene fibers exhibited an average fiber size of 2.32 microns and a basis weight of 8 gsm.

Example 3—Synthesis of Polypropylene Fiber Separator with the aid of nucleating agent (Inventive). In this example, a polypropylene fiber-based separator is prepared using the same procedure as Example 1, with the exception that 4 wt % of a sorbitol-based nucleating agent (Ultraclear GB 110BW, Milliken & Company) was added to the homopolymer polypropylene during the melt blowing process and the melt temperature at the die lip was 248° C. The produced polypropylene fibers exhibited an average fiber size of 2.12 microns and a basis weight of 8 gsm.

Example 4—Crystallinity, Tensile Strength. Shrinkage and Air Permeability Testing. In this Example, the separators produced in Examples 1-3 were evaluated for crystallinity (%), tensile strength, shrinkage and air permeability.

For crystallinity testing, measurements were taken using a Differential Scanning calorimeter (Netzsch DSC 2000 F3), following the test method Standard BIS 290. The percent crystallinity was calculated using the heat of enthalpy values observed in the first heating curve with the heat of enthalpy for 100% crystalline PP (207 J/g).

For tensile strength testing, samples were 5A type and pretreated to 23 C/50% humidity. Width and thickness were measured using a caliper. An extensiometer (Zwick Z020 (WP-1)) was used to perform the test using wedge clamping. The separation rate was 50 mm/min with a starting length of 50 mm.

For shrinkage testing, the samples were prepared using a 5 cm×5 cm die and punch. They were marked in the midpoint of the sample on each side (machine direction or “MD” and transverse direction or “TD”). They were placed on a PTFE sheet and placed horizontally in the oven at 120 C for 1 hr. A caliper was used to measure the change in dimension and reported in MD % shrinkage and TD % shrinkage. For air permeability testing, samples were cut into 200 mm×500 mm rectangles. The data was collected using a FX 3300 Air permeability tester (Tex Test Instruments). The samples were measured at four locations on each sample and reported as mean value. The air permeability tests were conducted using a pressure 125 pa.

The crystallinity (%), tensile strength, shrinkage and air permeability evaluation results for Examples 1-3 are provided in Table 1.

TABLE 1

| Test | Example 1 | Example 2 | Example 3 |
|---|---|---|---|
| Crystallinity (%) | 40.2 | 42.3 | 42.5 |
| Tensile Strength, | 11.2/8.0 | 12.6/8.9 | 10.5/7.1 |
| (MPa; MD/TD) | | | |
| Shrinkage | 1.2/04 | 0.9/08 | 0.6/0.3 |
| (%; MD/TD) | | | |
| Air Permeability | 9.46 | 17.3 | 29.1 |
| (cm³/s) | | | |

As illustrated in Table 1, the use of the nucleating agent leads to an increased crystallinity level compared to the control sample with no nucleating agent. This increase in the crystallinity translates into an increase in the tensile strength in the case of the Example 2 sample (2 wt % nucleating agent). There is a decrease in the shrinkage values with the addition of the nucleating agent, with shrinkage values decreasing as a function of increasing nucleating agent content. Further, an increase in the air permeability with the use of the nucleating agent is observed also, with air permeability values increasing as a function of increasing nucleating agent content. This is a key unexpected result as it means that the separators produced with nucleating agents provide less resistance during the operation of the battery.

Example 4—Charge/Discharge Capacity Testing. In this example, charge/discharge capacity testing was conducted for comparative and inventive separators in lithium-ion batteries having NMC 811 (LiNi_{0.8}Mn_{0.1}Co_{0.1}O₂) anodes. Four separators were tested as follows. Separator A is an inventive separator produced according to Example 2 and having a thickness of 15 microns. Separator B is an inventive separator produced according to Example 2 and having a thickness of 22 microns. Separator C is a comparative separator, Celgard® pp 1611 (a 16 micron thickness monolayer microporous polypropylene membrane). Separator D is a comparative separator, Celgard® 2500 (a 25 micron thickness monolayer microporous polypropylene membrane). In this example, 2 Ah pouch cells were prepared having separators as defined above, graphite anodes (loading˜3.0 mAh/cm²), NMC 811 anodes (loading˜3.0 mAh/cm²), and a lithium salt electrolyte solution.

Table 2 provides charge and discharge data (Formation at C/20) of the lithium-ion pouch cell batteries produced in this example.

TABLE 2

| | | | | | | | | DCIR - | DCIR - |
|---|---|---|---|---|---|---|---|---|---|
| | Avg. | | | | | | | DCh | Ch |
| | 5-10 | C1 | D1 | D2 | D3 | D4 | C.E. | R, | R, |
| Separator | cells | mAh | mAh | mAh | mAh | mAh | % | Ohms | Ohms |
| A | Avg | 2010 | 1764 | 1629 | 1624 | 1615 | 87.80 | 0.061 | 0.051 |
| | Stdev | 1.05% | 1.49% | 1.41% | 1.35% | 1.31% | 1.67% | 3.77% | 4.62% |
| B | Avg | 2036 | 1816 | 1665 | 1661 | 1652 | 89.20 | 0.073 | 0.062 |
| | Stdev | 0.63% | 0.70% | 0.83% | 0.82% | 0.84% | 0.40% | 10.06% | 11.59% |
| C | Avg | 2041 | 1795 | 1666 | 1665 | 1666 | 88.00 | 0.059 | 0.048 |
| | Stdev | 0.42% | 0.48% | 0.28% | 0.27% | 0.28% | 0.60% | 2.37% | 3.63% |
| D | Avg | 2040 | 1791 | 1651 | 1647 | 1648 | 87.80 | 0.063 | 0.052 |
| | Stdev | 0.27% | 0.33% | 0.40% | 0.42% | 0.44% | 0.13% | 2.99% | 3.01% |

Table 3 provides cycle life data at 0.3 C/0.3 C charge and discharge rates, performed using a Neware battery cycler, of the lithium-ion pouch cell batteries produced in this example.

TABLE 3

| Separator | % Loss | % Retention | Cycles |
|---|---|---|---|
| A | 3.24 | 96.76 | 500 |
| B | 3.66 | 96.34 | 500 |
| C | 4.33 | 95.67 | 464 |
| D | 5.37 | 94.63 | 468 |

Example 5—Charge/Discharge Capacity Testing. In this example, charge/discharge capacity testing was conducted for a comparative and an inventive separator in lithium-ion batteries having LFP (lithium iron phosphate) anodes. In this example, Separator E is an inventive separator produced according to Example 2 and having a thickness of 22 microns, Separator F is a comparative separator, Celgard® 2500 (a 25 micron thickness monolayer microporous polypropylene membrane). 0.1 Ah pouch cells were prepared with graphite anodes (loading˜1.2 mAh/cm²), LFP cathodes (loading˜1.2 mAh/cm), 1M LiPF6 EC:DMC (1:1 ethylene carbonate:dimethyl carbonate) and 2% vinylene carbonate.

Table 4 provides Cycle life data at 2 C/0.5 C charge and discharge rates, using a Neware battery cycler, of the lithium-ion pouch cell batteries produced in this example.

TABLE 4

| Sample | % Loss | % Retention | Cycle |
|---|---|---|---|
| E | 14.1% | 85.9% | 1,079 |
| F | 13.0% | 87.0% | 886 |

Although various embodiments have been described, it will readily be appreciated by those skilled in the art that many modifications and adaptations of the compositions, devices, and processes described herein are possible without departure from the spirit and scope of the embodiments as claimed. Thus, it is to be clearly understood that this description is made only by way of example and not as a limitation on the scope.

What is claimed is:

1. An article comprising a nonwoven fabric, the nonwoven fabric prepared by a process comprising:
forming polymer fibers from a bulk polymer in the presence of a nucleating agent; and
forming a nonwoven fabric from the polymer fibers.

2. The article of claim 1, wherein the article is in the form of a sheet having a thickness of up to about 50 μm.

3. The article of claim 1, wherein the article is a battery separator.

4. The article of claim 1, wherein the article is a lithium-ion battery separator.

5. The article of claim 1, wherein the bulk polymer comprises one or more of polypropylene, polyethylene, polyethylene terephthalate, a nylon, polycaprolactam, polyphenylene sulfide, polyetherimide, polyacrylate, polyacrylamide and polyacrylonitrile.

6. The article of claim 1, wherein the bulk polymer comprises polypropylene.

7. The article of claim 1, wherein the bulk polymer consists of polypropylene.

8. The article of claim 1, wherein the nucleating agent is selected from the group consisting of talc, nanoclays, metal oxides, alkaline earth metal phosphates, alkaline earth metal carbonates and alkaline earth metal sulphates.

9. The article of claim 1, wherein the nucleating agent is selected from the group consisting of sodium benzoate, lithium benzoate, sodium succinate, organophosphates, and salts thereof, phosphate esters, bicycloheptane salts, sorbitol-based compounds, trisamides, γ-quinacridone, dimethyl 5-sulfoisophthalate sodium salt, and alkyl dicarboxylic acids and salts thereof.

10. The article of claim 1, wherein forming the polymer fibers from the bulk polymer in the presence of the nucleating agent comprises subjecting a mixture of the bulk polymer and the nucleating agent to a melt blowing process.

11. The article of claim 1, wherein the polymer fibers are formed from a mixture having about 0.1 to about 10 parts by weight of the nucleating agent and about 90 to about 99.9 parts by weight of the bulk polymer.

12. The article of claim 1, wherein the polymer fibers are formed from a mixture having about 1.5 to about 6 parts by weight of the nucleating agent and about 94 to about 98.5 parts by weight of the bulk polymer.

13. The article of claim 1, wherein forming the nonwoven fabric from the polymer fibers comprises:
collecting the polymer fibers on a substrate; and
consolidating the polymer fibers on the substrate to form the nonwoven fabric.

14. The article of claim 13, wherein the substrate is a forming wire, a fabric or a drum.

15. The article of claim 13, wherein consolidating the polymer fibers on the substrate is performed by any one of a calendering process, compaction rolling process and a creping process.

16. The article of claim 1, wherein the bulk polymer comprises a mixture of at least two of polypropylene, polyethylene, polyethylene terephthalate, a nylon, polycaprolactam, polyphenylene sulfide, polyetherimide, polyacrylate, polyacrylamide and polyacrylonitrile.

17. The article of claim 1, wherein the nonwoven fabric exhibits an air permeability of more than 10 cm³/s.

18. The article of claim 1, wherein the nonwoven fabric exhibits a shrinkage of less than 1% in one or both of a machine direction and a transverse direction.

19. A battery comprising an article according to claim 1.

20. The battery of claim 19, further comprising an anode, a cathode, and an electrolyte solution comprising a lithium salt.
